(19) United States
(12) Patent Application Publication
(10) Pub. No.: US 2008/0084680 A1
(43) Pub. Date: Apr. 10, 2008

(54) SHARED DOCKING BAY ACCOMMODATING EITHER A MULTIDRIVE TRAY OR A BATTERY BACKUP UNIT

(76) Inventors: Shah Mohammad Rezaul Islam, Tucson, AZ (US); Gregg S. Lucas, Tucson, AZ (US); Ronald D. Parrish, Tucson, AZ (US); Michihiro Okamoto, Kawasaki-Shi (JP); Tohru Sumiyoshi, Tokyo (JP)

Correspondence Address: DILLON & YUDELL, LLP, 8911 N CAPITAL OF TEXAS HWY, SUITE 2110, AUSTIN, TX, 78759, US

(21) Appl. No.: 11/539,776

(22) Filed: Oct. 9, 2006

(51) Int. Cl. H01R 12/16

(52) U.S. Cl. 361/788

(57) ABSTRACT

The present invention provides a method for allowing a multi-drive tray (MDT) to be interchanged with a battery backup unit (BBU) tray within a disk enclosure blade (DEB) of a blade server. The DEB is implemented comprising a plurality of controller cards and a plurality of MDTs. One of the MDT slots within the DEB is configured to be interchanged with a BBU tray. The BBU tray is designed to include multiple BBUs and is configured to have packaging, mounting, and air flow characteristics that are similar to an MDT. In one embodiment, a controller card queries each MDT slot within the DEB and determines if any of the queried MDT slots contain a BBU tray. If a queried MDT slot contains a BBU tray, the controller card manages the queried MDT slot as a BBU slot. Otherwise, the controller card manages the queried MDT slot as an MDT slot.

### BACKGROUND OF THE INVENTION

1. Technical Field

The present invention relates in general to the field of computers and other data processing systems and in particular to blade servers. Still more particularly, the present invention relates to an improved method and system for allowing blade server components to be interchangeable.

2. Description of the Related Art

Computer systems utilize many different peripheral devices. With the advent of disk arrays, in which a number of hard disk drives are used together by a data processing system to increase data storage capacity, manufacturers adopted the approach of mounting a number of disk drives within a single enclosure, also referred to as a multi-drive tray (MDT). Conventional host computers and disk drive controllers are also designed to operate different disk drives in an inter-related fashion. Data distribution is utilized to substantially increase data transfer rates, and also to facilitate error correction by using redundancy to improve reliability. These developments have also led to the introduction of a number of variants, such as the Redundant Array of Inexpensive Disks (RAID) function.

Features currently available in computer systems include the use of exchangeable spare drives and the mounting of disk drives and other peripherals in plug-in cassettes, canisters, or trays of different configurations. These features allow peripherals to be inserted into and retained in an enclosure while also providing electrical power and data transfer connections. Conventional peripherals can typically be removed via a “hot swapping” approach that precludes the need for a system shutdown. There are now many different types of enclosures for removable computer peripheral devices. These and other units incorporate local controllers, power supplies, and interconnects for the different computer peripheral devices. Note that in a typical configuration, each peripheral is mounted and electrically coupled via a unique bay. That is, the size, shape, mounting hardware, and electrical connectors in a bay designed to accommodate a hard drive are different than those of a bay that is designed to accommodate a battery.

As array systems and structures have become increasingly prevalent, demand has increased for greater performance versatility and reduced cost. Different storage devices are designed to meet different needs. Storage subsystems are being integrated into blade server chassis to create “store-in-a-box” solutions. Common hardware/firmware components, such as the four basic field replacement units (FRUs), may be utilized across the different types of conventional disk enclosure blade (DEB) storage subsystems. The four basic FRUs include an MDT having up to three hard disk drives (HDDs), a controller card used to interface with multiple MDTs, a RAID controller card, and an enclosure with an internal midplane. In systems using the integrated RAID controller disk enclosure blade (I-DEB) configuration, the controller card for the MDTs must be replaced with a RAID controller card. The space required to fit RAID controllers within conventional I-DEB systems makes it impossible to also include a battery backup unit (BBU), which is fundamental to the operation of RAID controllers.

### SUMMARY OF THE INVENTION

In order to maintain commonality and leverage the four FRUs mentioned above, it is desirable to provide a method and system for including a BBU in a DEB system. Therefore, disclosed is a method and system for allowing a multi-drive tray (MDT) to be interchanged with a battery backup unit (BBU) tray within a disk enclosure blade (DEB). A DEB is implemented as comprising a plurality of controller cards and a plurality of MDTs. One of the MDT slots within the DEB is configured to be interchanged with a BBU tray. The BBU tray is designed to include multiple BBUs and is configured to have packaging, mounting, and air flow characteristics that are similar to a MDT. In one embodiment, the method includes, but is not limited to, the steps of: querying each MDT slot, from among a plurality of MDT slots within the DEB, to determine if a queried MDT slot contains a BBU tray; managing the queried MDT slot as a BBU slot during future interactions between the DEB and the queried MDT slot if the queried MDT slot contains a BBU tray; and managing the queried MDT slot as an MDT slot during future interactions between the DEB and the queried MDT slot if the queried MDT slot contains an MDT.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary blade server, as utilized in an embodiment of the present invention;

FIG. 2 illustrates a battery backup unit (BBU) tray and a multi-drive tray (MDT), as used in an embodiment of the present invention;

FIG. 3 depicts a blade server midplane, as used in an embodiment of the present invention; and

FIG. 4 is a high level logical flowchart of an exemplary method of enabling a MDT to be interchangeable with a BBU tray within a disk enclosure blade (DEB), in accordance with one embodiment of the invention.

### DETAILED DESCRIPTION OF AN ILLUSTRATIVE EMBODIMENT

The present invention provides a method and system for allowing a multi-drive tray (MDT) to be interchangeable with a battery backup unit (BBU) tray within a disk enclosure blade (DEB).

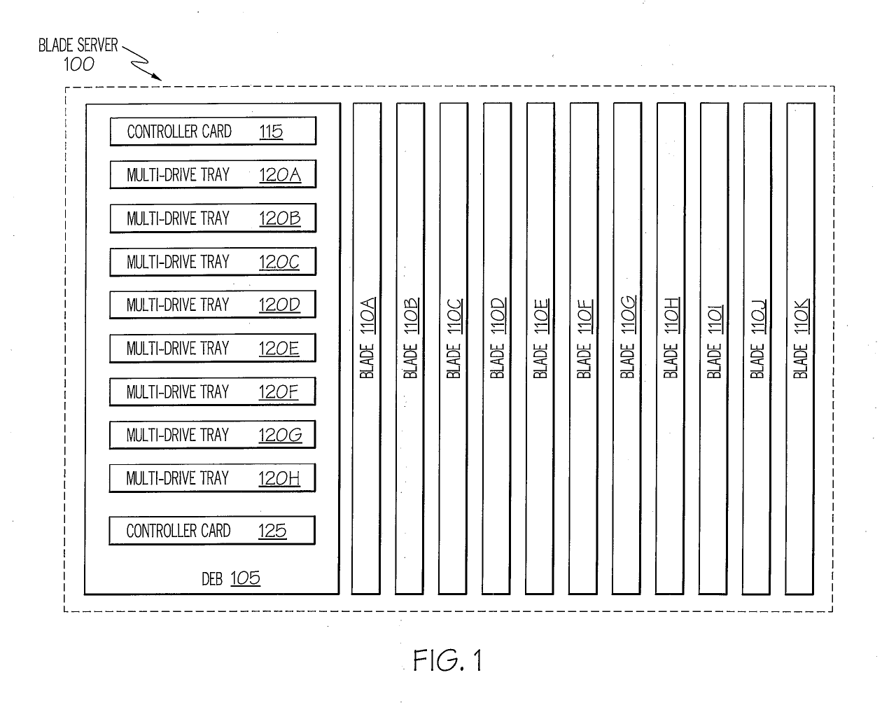

With reference now to FIG. 1, there is depicted a high level block diagram of an exemplary blade server 100, within which the present invention may be utilized. Blade server 100 includes a DEB 105 and up to eleven blades (110A through 110K). According to the illustrative embodiment, DEB 105 comprises a controller card 115, up to eight MDTs (120A through 120H), and a second controller card 125. DEB 105 is essentially a chassis within the chassis of blade server 100. In another embodiment, DEB 105 may include two redundant array of inexpensive disks (RAID) controller cards instead of controller cards 115 and 125.

Controller cards 115 and 125 are each utilized to control the interfaces between multiple MDTs and a Serial Attached Small Computer System Interface (SAS) switch, which allows the MDTs to be communicatively connected to the plurality of processors in blades 110A through 110K. Similarly, in another embodiment RAID controller cards may be utilized to control the RAID functionality of the plurality of hard disk drives (HDDs) within each MDT. Since all DEB designs utilize a plurality of HDDs, it is crucial to integrate as much data storage capacity as possible. The present invention thus allows a user of blade server 100 to interchange an MDT with a BBU tray containing two BBUs in order to provide one BBU per controller without sacrificing additional volume in DEB 105. In an alternate embodiment, two MDT slots are replaced by two BBU trays, each of which contains a single BBU.

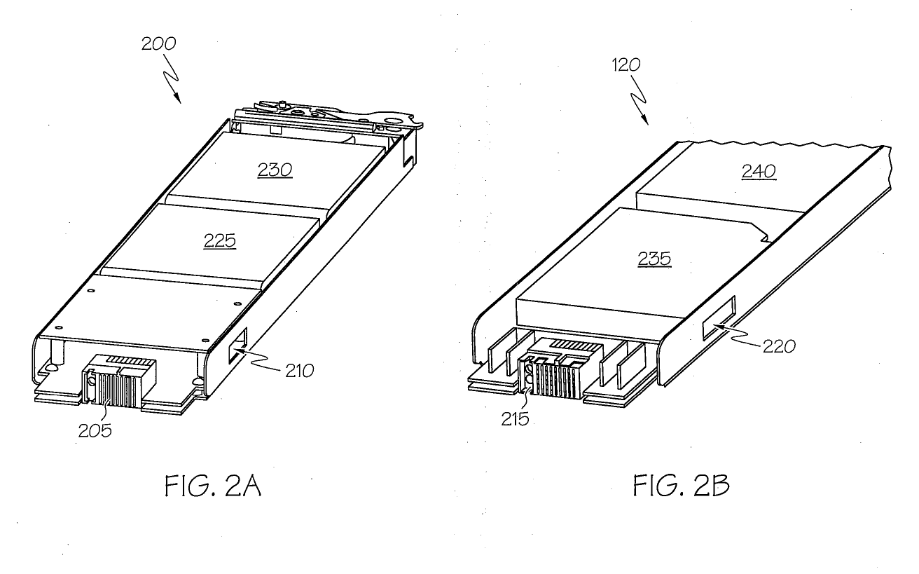

Within the descriptions of the figures, similar elements are provided, similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

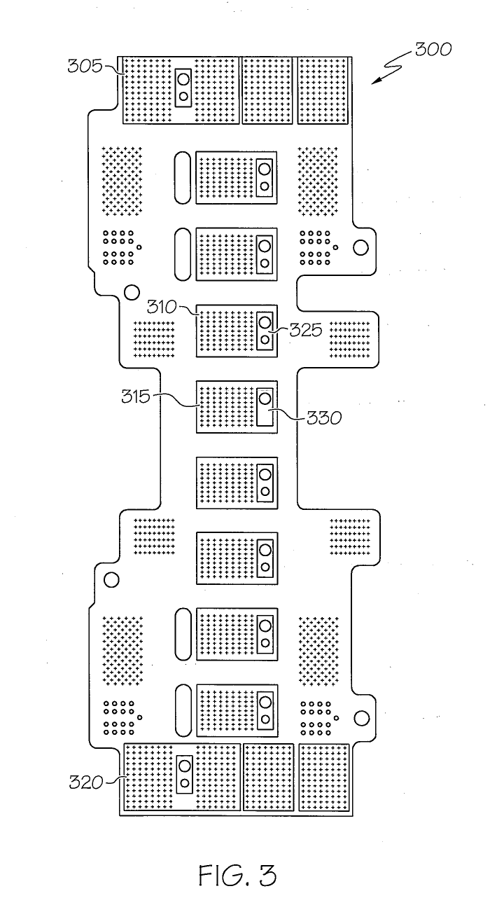

With reference now to FIG. 2, there is depicted a battery backup unit (BBU) tray 200 and MDT 120, as used in an embodiment of the present invention. BBU tray 200 comprises a connector having a single key hole 205, a reduced air hole 210, and up to two BBUs (225 and 230). BBU 225 and BBU 230 are each capable of providing BBU functionality to a separate controller card (i.e. controller card 115 or controller card 125). Single key hole 205 is utilized to couple BBU tray 200 to DEB 105 via a midplane, which is illustrated in FIG. 3 and discussed in detail below. Reduced air hole 210 provides cooling to the components within BBU tray 200.

MDT 120 comprises a connector having two key holes 215, a standard air hole 220, HDD 235, and HDD 240. HDD 235 and HDD 240 are utilized to store data and may be accessed by blades 110A through 110K. Although FIG. 2 depicts MDT 120 as including two HDDs (235 and 240), MDT 120 may include up to three HDDs. Standard air hole 220 provides cooling to the components within MDT 120. MDT 120 utilizes two key holes 215 to connect to DEB 105 via a midplane, which is illustrated in FIG. 3 and discussed in detail below.

With reference now to FIG. 3, there is depicted a midplane 300 within DEB 105, as used in an embodiment of the present invention. Midplane 300 comprises a controller card connector 305, up to seven MDT connectors 310, a BBU tray connector 315, and a second controller card connector 320. BBU tray connector 315 provides a superset of connectivity for either an MDT or a BBU tray. In a preferred embodiment, controller card connectors 305 and 320 are capable of supporting either a controller card or a RAID controller card. In an alternate embodiment, midplane 300 may include two RAID controller card connectors instead of controller card connectors 305 and 320.

Each of the plurality of MDT connectors 310 includes two key pegs 325, which are utilized to connect MDT 125 to midplane 300. Each MDT 120A through 120H utilizes an Inter-Integrated Circuit (I²C) interface to communicate with controller cards 115 and 125 within DEB 105. Similarly, BBU tray connector 315 includes a single key peg 330, which is utilized to connect BBU tray 200 to midplane 300. Single key peg 330 also prevents BBU tray 200 from being physically installed into an MDT slot equipped with MDT connector 310. Midplane 300 is coupled to DEB 105, which is in turn coupled to other devices within blade server 100 (e.g. blades 110A through 110K). Midplane 300 thus enables the devices within DEB 105 to be communicatively connected with each other and/or blades 110A through 110K.

In one embodiment, electrical output signals, including, but not limited to, battery backup power and I²C interfaces, are produced by BBU tray 200 and combined with output signals sent from one or more of MDTs 120A through 120H via a multiplex (MUX) operation. After the MUX operation, the output signals may be transmitted to controller card 115 and/or controller card 125 via midplane 300. In an alternate embodiment, BBU tray 200 generates unique output signals that are sent to controller card 115 and/or controller card 125 separately from the output signals of MDTs 120A through 120H.

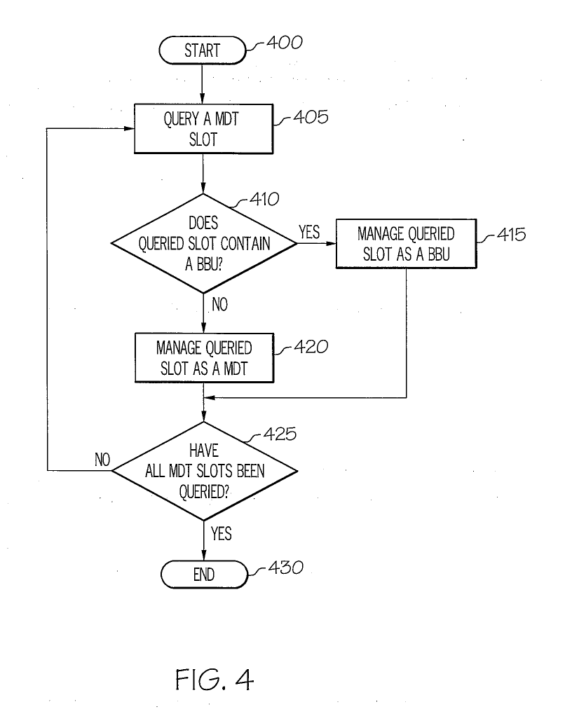

Turning now to FIG. 4, there is illustrated a high level logical flowchart of an exemplary method of allowing a MDT to be interchangeable with a BBU tray within a DEB, in accordance with one embodiment of the invention. The process begins at block 400, for example, in response to controller card 115 and/or controller card 125, detecting a presence of a new component coupled to DEB 105. In one embodiment, controller card 115 performs the steps illustrated in FIG. 4 in an automated manner. In an alternate embodiment, the illustrated steps can be performed by controller card 125 or by a RAID controller card. At block 405, controller card 115 queries a MDT slot. An MDT slot is defined as a slot within DEB 105 that may contain one of MDTs 120A through 120H or a BBU tray 200.

At block 410, a determination is made whether the queried slot contains BBU tray 200. If the queried slot contains, BBU tray 200, controller card 115 manages the queried slot as a BBU during future interactions with the queried slot, as depicted at block 415. If the queried slot does not contain BBU tray 200, controller card 115 manages the queried slot as a MDT during future interactions with the queried slot, as depicted at block 420.

A determination is made at block 425 whether all MDT slots within DEB 105 have been queried. If all MDT slots within DEB 105 have not been queried, controller card 115 returns to block 405, where the next MDT slot is queried. In response to a determination by controller card 115 that all MDT slots within DEB 105 have been queried, the process terminates at block 430. The present invention thus allows BBU tray 200 to be interchangeable with MDT tray 120 within DEB 105.

It is understood that the use herein of specific names are for example only and not meant to imply any limitations on the invention. The invention may thus be implemented with different nomenclature/terminology and associated functionality utilized to describe the above devices/utility, etc., without limitation.

The present invention thus provides a method of allowing MDT 120 to be interchangeable with BBU tray 200 within DEB 105. In one embodiment, the method includes, but is not limited to, the steps of: querying each MDT slot, from among a plurality of MDT slots within DEB 105, to determine if a queried MDT slot contains BBU tray 200; managing the queried MDT slot as a BBU during future interactions with the BBU if the queried MDT slot contains BBU tray 200; and managing the queried MDT slot as MDT 120 during future interactions with MDT 120 if the queried MDT slot contains MDT 120.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method of enabling a multi-drive tray (MDT) to be interchanged with a battery backup unit (BBU) tray within a disk enclosure blade (DEB), the method comprising:
querying each MDT slot, from among a plurality of MDT slots within the DEB, to determine if a queried MDT slot contains a BBU tray;
managing the queried MDT slot as a BBU slot during future interactions between the DEB and the queried MDT slot if the queried MDT slot contains the BBU tray; and
managing the queried MDT slot as an MDT slot during future interactions between the DEB and the queried MDT slot if the queried MDT slot contains an MDT.

2. The method of claim 1, wherein the step of querying each MDT slot from among the plurality of MDT slots within the DEB is performed by a controller card within the DEB.

3. The method of claim 1, wherein the steps of managing the queried slot as the BBU includes utilizing a multiplex operation to combine output signals sent from the BBU with output signals sent from the plurality of MDT slots, wherein muxed output signals are read individually by the controller card within the DEB.

4. The method of claim 1, wherein the steps of managing the queried slot as the BBU includes utilizing an output signal sent from the BBU that is separate from output signals sent from the plurality of MDT slots.

5. The method of claim 1, wherein the steps of managing the queried slot as the MDT includes utilizing inter-integrated circuit (I²C) interfaces within the controller card, wherein the I²C interfaces act as busses that enable the controller card to access the MDT.

6. A system comprising:
a disk enclosure blade (DEB);
a midplane coupled to the DEB, wherein the midplane comprises multiple controller card connectors, a plurality of multi-drive tray (MDT) connectors, and a multi-function connector configured to connect to either a battery backup unit (BBU) or a multi-drive tray (MDT);
a plurality of controller cards communicatively coupled to the midplane;
a plurality of MDTs communicatively coupled to the midplane; and
a BBU tray communicatively coupled to the midplane, wherein the BBU tray comprises a BBU connector, an opening to facilitate ventilation, and packaging configured for enabling the BBU tray to be interchangeably connected to the midplane via one of the MDT slots.

7. The system of claim 6, wherein the BBU tray further comprises a plurality of BBUs.

8. The system of claim 6, wherein the opening to facilitate cooling within the BBU tray is physically smaller than an opening to facilitate cooling within the MDT.

9. The system of claim 6, wherein the MDT includes an MDT connector that includes two key holes and the multi-function connector on the BBU tray includes a single key hole.

10. The system of claim 6, wherein each of the plurality of MDT connectors on the midplane includes two key pegs.

11. The system of claim 6, wherein the BBU connector is configured to connect to either the BBU or the MDT on the midplane, and wherein the BBU connector includes a single key peg.
